(19) United States
(12) Patent Application Publication
(10) Pub. No.: US 2009/0038860 A1
(43) Pub. Date: Feb. 12, 2009

(54) Interactive projection apparatus

(76) Inventor: Chung-Jen Huang, Sheung Shui (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,567

(22) Filed: Nov. 20, 2007

(30) Foreign Application Priority Data
Aug. 9, 2007 (TW) 96213134

(51) Int. Cl. G06F 3/041

(52) U.S. Cl. 178/18.01

(57) ABSTRACT

An interactive projection apparatus is provided, which utilizes a control module to monitor the image of the touch control display screen to generate a control signal, then referring to the content mark of the display image, and so as to make the projection apparatus of the present invention have an interactive function with users. Therefore, the interactive projection apparatus of the present invention has the advantages including reader interaction, simple structure and relative cheapness, such that it can be widely applied as a children toy, a talking book, an interactive reading matter and a teaching assistance apparatus.

### BACKGROUND OF THE INVENTION

1. Field of the Invention

The present invention generally relates to an interactive projection apparatus, and more particularly relates to an interactive projection apparatus with a touch control display screen.

2. Description of the Prior Art

Conventionally, most children toys having word or painting content with interactive function utilize sensing devices to set between the book content. The sensing devices will detect the arrived position of an approaching transceiver to make specific sound or other corresponding actions.

Because the sensing devices are set in the book, it is uneasy to minimize the book size and lower down the book cost. Meanwhile, the content is limited and tedious.

### SUMMARY OF THE INVENTION

To solve the aforementioned problems, one object of the present invention is to provide an interactive projection apparatus utilizing a control module to monitor the image of the touch control display screen to generate a control signal, then referring to the content mark of the display image, and so as to make the projection apparatus of the present invention have an interactive function with users.

Therefore, the interactive projection apparatus of the present invention has the advantages including reader interaction, simple structure, diversified content and relative cheapness. Accordingly, the interactive projection apparatus of the present invention can be served as an interactive apparatus having word or painting content with a reader, such that it can be widely applied as a children toy, a talking book, an interactive reading matter and a teaching assistance apparatus.

In accordance with the above objectives and other purposes of the present invention, an embodiment of an interactive projection apparatus is provided, which includes: a touch control display screen to display images and generate an input signal when a surface of the touch control display screen is touched; and a mainbody of the projection apparatus electrically connected with the touch control display screen, wherein the mainbody of the projection apparatus includes: a projection module to project an image onto the touch control display screen; and a control module to receive the input signal and then generate a control signal.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG.1, FIG.2 and FIG.3 are respectively a structure block diagram for a mainbody of a projection apparatus, an application schematic diagram of an interactive projection apparatus and a schematic diagram of a touch control display screen according to an embodiment of the present invention;

FIG.4 is a schematic diagram of a touch control display screen for an interactive projection apparatus according to an embodiment of the present invention;

FIG.5 is a structure schematic diagram for a mainbody of a projection apparatus according to an embodiment of present invention; and

FIG.6 is an application schematic diagram of an interactive projection apparatus according to an embodiment of present invention.

### DESCRIPTION OF THE PREFERRED EMBODIMENT

Other advantages of the present invention will become apparent from the following description taken in conjunction with the accompanying drawings wherein are set forth, by way of illustration and example, certain embodiments of the present invention.

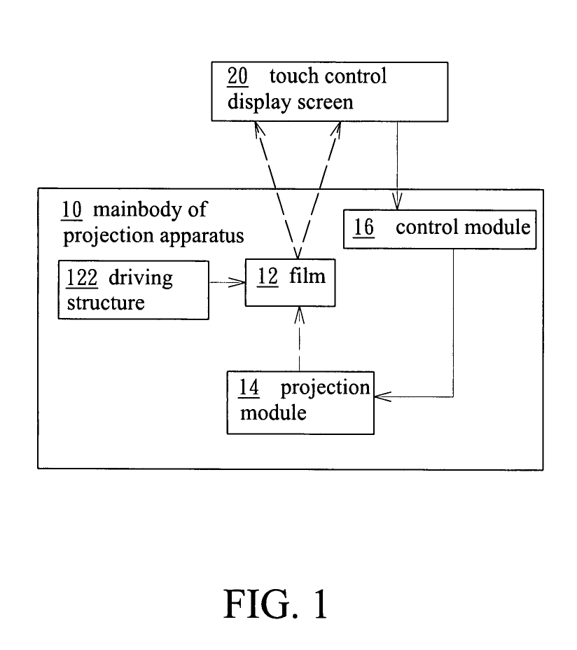

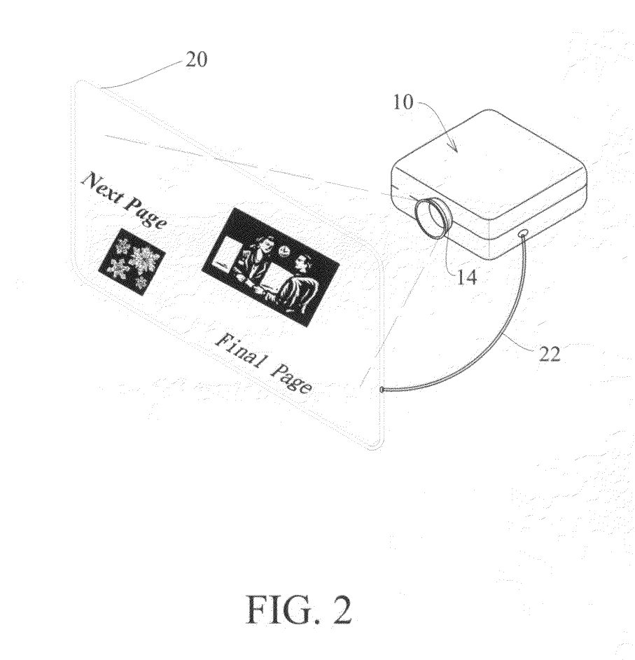

Please refer to FIG.1, FIG.2 and FIG.3, which are respectively a structure block diagram for a mainbody 10 of a projection apparatus, an application schematic diagram of an interactive projection apparatus and a schematic diagram of a touch control display screen 20 according to an embodiment of the present invention. The interactive projection apparatus includes: a touch control display screen 20 to display images and generate an input signal when a surface of the touch control display screen is touched; and a mainbody 10 of the projection apparatus electrically connected with the touch control display screen 20 through a signal line 22, wherein the mainbody 10 of the projection apparatus includes: a projection module 14 to project an image onto the touch control display screen 20; and a control module 16 to receive the input signal and then generate a control signal, wherein the mainbody 10 of the projection apparatus will produce a preset action according to the control signal, such as a page jump, a page change or a voice speaking.

In this embodiment, the input signal is generated by utilizing a pointer 30 to touch the touch control display screen 20. The pointer 30 can be a stylus pen or a retractable pointer in one embodiment.

In one embodiment, the touch control display screen 20 can be a glass-type, capacitance-type or resistance-type touch panel.

In one embodiment, the mainbody 10 of the projection apparatus can be a front projection, Liquid Crystal Display (LCD), Digital Light Processing (DLP) or Liquid Crystal on Silicon (LCOS) projector.

Please continuously refer to FIG.1, in one embodiment, the mainbody 10 of the projection apparatus may include at least one film 12 and a driving structure 122 to drive the film 12 to move or rotate.

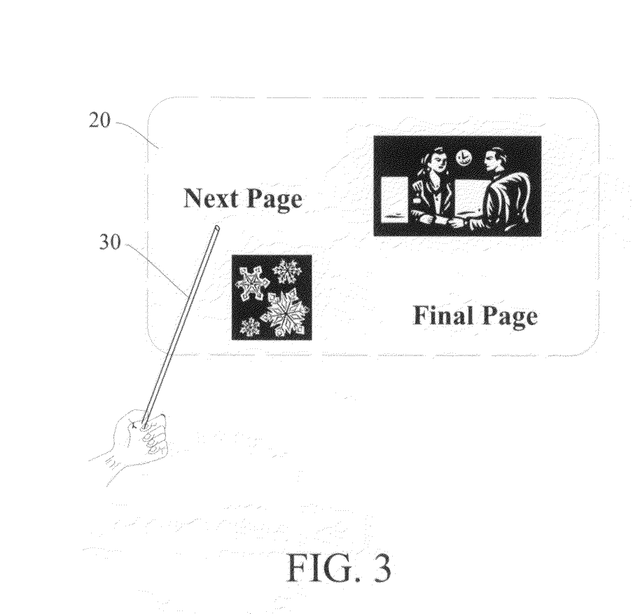

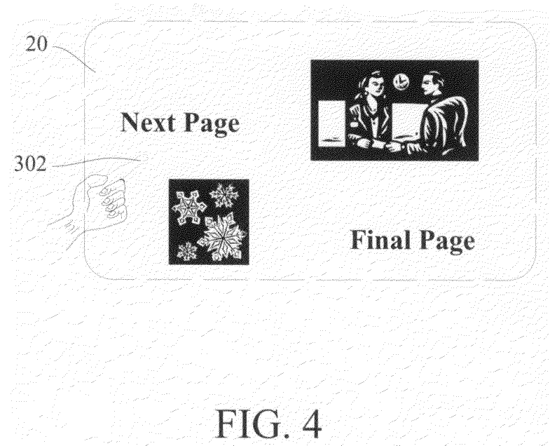

Please refer to FIG.4, in one embodiment, the input signal is generated by a human finger 302 touching the touch control display screen 20.

Therefore, one feature of the present invention is utilizing a control module to monitor the image of the touch control display screen to generate a control signal, then referring to the content mark of the display image, and so as to make the projection apparatus of the present invention have an interactive function with users.

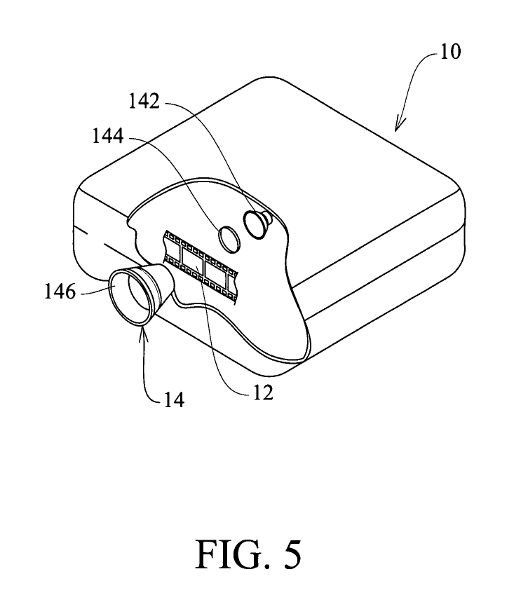

Please refer to FIG.5, in one embodiment, the mainbody 10 of the projection apparatus may include a light source 142, a condense lens 144 or an image lens 146.

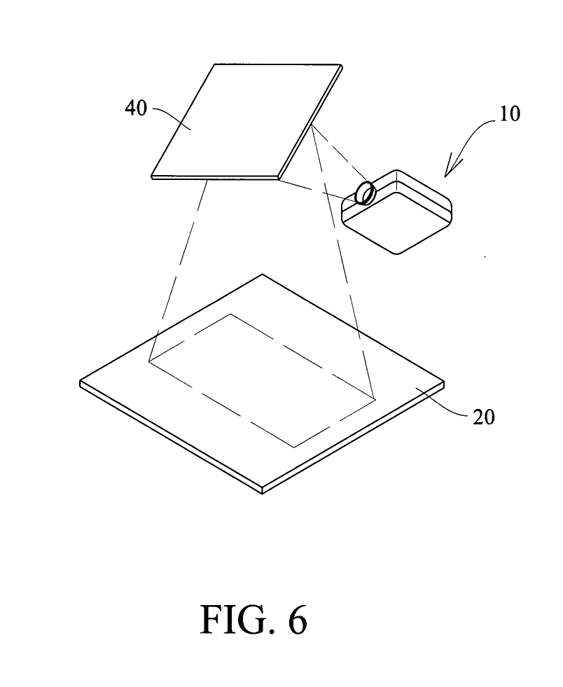

Please refer to FIG.6, in one embodiment, the mainbody 10 of the projection apparatus may firstly project an image onto a mirror 40 and then reflect the image onto the touch control display screen 20.

To sum up, the interactive projection apparatus of the present invention has the advantages including reader interaction, simple structure and relative cheapness. Accordingly, the interactive projection apparatus of the present invention can be served as an interactive apparatus having word or painting content with a reader, such that it can be widely applied as a children toy, a talking book, an interactive reading matter and a teaching assistance apparatus.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An interactive projection apparatus, comprising:
a touch control display screen to display images and generate an input signal when a surface of the touch control display screen is touched; and
a mainbody of the projection apparatus electrically connected with the touch control display screen, wherein the mainbody of the projection apparatus comprises:
a projection module to project an image onto the touch control display screen; and
a control module to receive the input signal and then generate a control signal.

2. The interactive projection apparatus according to claim 1, wherein the mainbody of the projection apparatus is electrically connected with the touch control display screen through a signal line.

3. The interactive projection apparatus according to claim 1, wherein the mainbody of the projection apparatus comprises at least one film.

4. The interactive projection apparatus according to claim 3, wherein the mainbody of the projection apparatus comprises a plurality of films and a driving structure to drive the films to move or rotate.

5. The interactive projection apparatus according to claim 1, wherein the mainbody of the projection apparatus will produce a preset action comprising a page jump, a page change or a voice speaking according to the control signal.

6. The interactive projection apparatus according to claim 1, wherein the input signal is generated by utilizing a pointer to touch the touch control display screen.

7. The interactive projection apparatus according to claim 1, wherein the pointer is a stylus pen, a retractable pointer or a human finger.

8. The interactive projection apparatus according to claim 1, wherein the mainbody of the touch control display screen is a glass-type, capacitance-type or resistance-type touch panel.

9. The interactive projection apparatus according to claim 1, wherein the mainbody of the projection apparatus is a front projection, LCD, DLP or LCOS projector.

10. The interactive projection apparatus according to claim 1, wherein the projection module comprises a light source, a condense lens or an image lens.

11. The interactive projection apparatus according to claim 1, wherein the interactive projection apparatus firstly project an image onto a mirror and then reflect the image onto the touch control display screen.

12. The interactive projection apparatus according to claim 1, wherein the interactive projection apparatus is a children toy, a talking book, an interactive reading matter or a teaching assistance apparatus.
